(19) United States
(12) Patent Application Publication
(10) Pub. No.: US 2012/0110237 A1
(43) Pub. Date: May 3, 2012

(54) METHOD, APPARATUS, AND SYSTEM FOR ONLINE MIGRATING FROM PHYSICAL MACHINE TO VIRTUAL MACHINE

(76) Inventors: Bin LI, Shenzhen (CN); Xin Zhang, Shenzhen (CN); Jihai Wang, Shenzhen (CN)

(21) Appl. No.: 13/341,427

(22) Filed: Dec. 30, 2011

Related U.S. Application Data
(63) Continuation of application No. PCT/CN2010/077052, filed on Sep. 17, 2010.

(30) Foreign Application Priority Data
Dec. 1, 2009 (CN) 200910188479.5

(51) Int. Cl. G06F 12/02; G06F 12/16

(52) U.S. Cl. 711/6; 711/E12.002

(57) ABSTRACT

A method, an apparatus, and a system for online migrating from a physical machine to a virtual machine are provided. The method including: after a target virtual machine is created, started, and suspended by a virtualization platform VMM Host, initially synchronizing data of a memory page from a source physical machine to the target virtual machine at a second time point; monitoring the operation of updating the memory page since the second time point; incrementally synchronizing data of the updated memory page in the source physical machine to the target virtual machine, and stopping monitoring when an increment value of the updated memory page in the source physical machine is less than a first threshold; and calling the virtualization platform VMM Host to resume the target virtual machine to a running state. The effect of smoothly switching services from the source physical machine to the target virtual machine is achieved.

### CROSS-REFERENCE TO RELATED APPLICATIONS

This application is a continuation of International Application No. PCT/CN2010/077052, filed on Sep. 17, 2010, which claims priority to Chinese Patent Application No. 200910188479.5, filed on Dec. 1, 2009, both of which are hereby incorporated by reference in their entireties.

### FIELD OF THE INVENTION

The present invention relates to the field of communication, and particularly, to a method, an apparatus, and a system for online migrating from a physical machine to a virtual machine.

### BACKGROUND OF THE INVENTION

With the maturation of the virtualization technique, the improvement of the performance of current hardware devices, and the damage or aging of the original devices, more and more users prefer to migrate the system on the old device to the new hardware with the virtualization technique, so as to save costs of maintenance and energy consumption, and to reduce occupation space. During the migration process, the Physical Machine to Virtual Machine (P2V) tool shall be used.

The P2V tool is adapted to migrate systems and applications in the existed physical host to the virtual host quickly and cleanly, so as to avoid reinstalling the software and configuring a complex application environment, thereby reducing the time of deploying and applying the virtualization. The current P2V tool includes:

an offline P2V tool, which restarts the source physical host and boots with a P2V optical disc to complete the migration, wherein the source physical machine is in an offline state and its service shall be interrupted during the whole migration process. Thus the solution is not suitable to some occasions where the service cannot be paused;

an online P2V tool, which completes the migration by installing an agent on the source physical host in a running state, wherein the source physical host runs normally during the migration process, thereby achieving the migration for certain physical machines whose services cannot be stopped. The current online P2V solution ensures that the service of the source physical machine will not be influenced during the process of the migration from the source physical machine to the target virtual machine. However, when developing the present invention, the inventor finds that after the migration is completed with the current online P2V tool, a service pause or interruption will still occur when the service is switched to the virtual machine.

### SUMMARY OF THE INVENTION

The embodiments of the present invention provide a method, an apparatus and a system for online migrating from a physical machine to a virtual machine, so that after the migration is completed, following the state of the source physical machine, the virtual machine takes over and continues running, thereby achieving the object of smoothly switching services from the source physical machine to the virtual machine.

The embodiments of the present invention provide the following technical solutions.

A method for online migrating from a physical machine to a virtual machine, including processes of:

after a target virtual machine is created, started and suspended by a virtualization platform VMM Host, initially synchronizing data of a memory page from a source physical machine to the target virtual machine at a second time point;

monitoring the operation of updating the memory page since the second time point;

incrementally synchronizing data of the updated memory page in the source physical machine to the target virtual machine, and stopping the monitoring when an increment value of the updated memory page in the source physical machine is less than a first threshold; and

calling the virtualization platform VMM Host to resume the target virtual machine to a running state.

And, an online Live-P2V logic functional entity, including: a controlling module, a memory data migration module and a communication module, wherein,

the controlling module is configured to call a virtualization platform VMM Host to perform the control of creating, starting and suspending a target virtual machine, and call the virtualization platform to resume the target virtual machine to a running state in response to a stop of monitoring by the memory data migration module;

the communication module is configured to provide a data migration channel from a source physical machine to the target virtual machine; and

the memory data migration module is configured to initially synchronize data of a memory page from the source physical machine to the target virtual machine through the data migration channel at a second time point, after the target virtual machine is suspended; monitor the operation of updating the memory page since the second time point; incrementally synchronize data of the updated memory page in the source physical machine to the target virtual machine through the data migration channel, and stop the monitoring when an increment value of the updated memory page in the source physical machine is less than a first threshold.

And, a migration system adaptive to an online migration from a source physical machine to a target virtual machine, the system including the source physical machine and a target virtual server in a network connection, wherein,

the source physical machine has an operating system (OS) running thereon, and the OS has at least one service and an online Live-P2V logic functional entity running thereon, the online Live-P2V logic functional entity being configured to after the target virtual machine is created, started, and suspended by a virtualization platform VMM Host of the target virtual server, initially synchronize data of a memory page from the source physical machine to the target virtual machine at a second time point, monitor the operation of updating the memory page since the second time point; incrementally synchronize data of the updated memory page in the source physical machine to the target virtual machine, and stop the monitoring when an increment value of the updated memory page in the source physical machine is less than a first threshold, and call the virtualization platform of the target virtual server to resume the target virtual machine to a running state; and

the target virtual server is deployed with the virtualization platform, wherein the virtualization platform is configured to create and start the target virtual machine, put the target virtual machine in a suspended state, and resume the target virtual machine to the running state in response to the calling by the online Live-P2V logic functional entity.

The embodiments of the present invention are applied in the scene of an online migration from a source physical machine to a target virtual machine. The data of the memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

### BRIEF DESCRIPTION OF THE DRAWINGS

In order to describe the technical solutions of the embodiments of the present invention and those in the prior art more clearly, the drawings to be used in the descriptions of the embodiments or the prior art are briefly introduced as follows. Obviously, the following drawings merely illustrate some embodiments of the present invention, and a person skilled in the art can obtain other drawings from these drawings without paying any creative effort.

FIG. 1 is a deployment logic diagram of a migration system according to an embodiment of the present invention;

FIG. 2 is an application context diagram of a migration system according to an embodiment of the present invention;

FIG. 3 is a flowchart of a method for online migrating from a physical machine to a virtual machine according to an embodiment of the present invention;

FIG. 4 is a flowchart of another method for online migrating from a physical machine to a virtual machine according to an embodiment of the present invention;

FIG. 5 is an interactive diagram of a method for online migrating from a physical machine to a virtual machine according to an embodiment of the present invention;

FIG. 5a is a record diagram of an updated data block;

FIG. 6 is a structural diagram of a Live-P2V logic functional entity according to an embodiment of the present invention;

FIG. 6a is an internal logic structural diagram of a disk data migration module 604 in a Live-P2V logic functional entity according to an embodiment of the present invention;

FIG. 6b is an internal logic structural diagram of a memory data migration module 602 in a Live-P2V logic functional entity according to an embodiment of the invention;

### DETAILED DESCRIPTION OF THE EMBODIMENTS

The technical solutions of the embodiments of the present invention will be clearly and completely described as follows in conjunction with the drawings. Apparently, the described embodiments are just a part of embodiments of the present invention rather than all of the embodiments. Based on the embodiments of the present invention, any other embodiment obtained by a person skilled in the art without paying a creative effort will fall within the protection scope of the present invention.

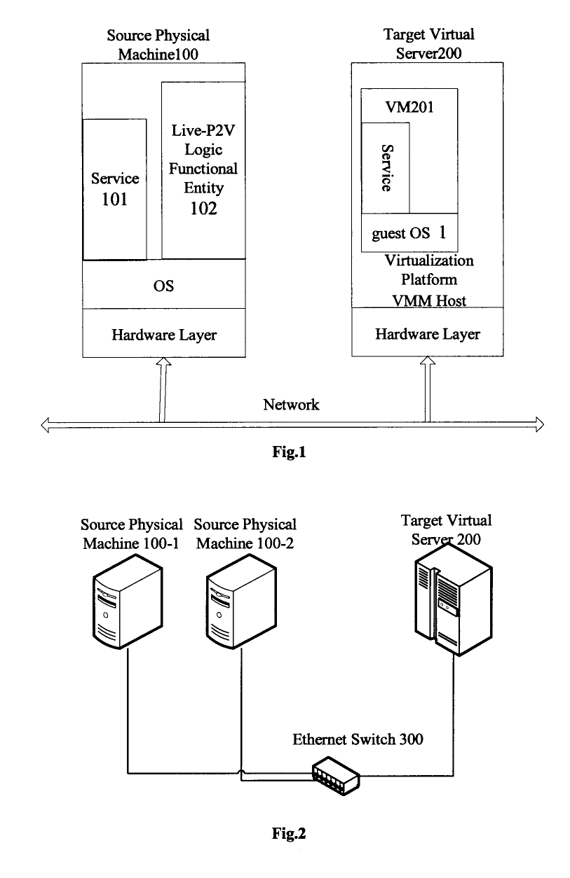

Referring to FIG. 1, which is a deployment logic diagram of a migration system according to an embodiment of the present invention, and which is adaptive to the scene of an online migration from a source physical machine to a target virtual machine. As illustrated in FIG. 1, the system includes a source physical machine 100 and a target virtual server 200 connected to a network.

The source physical machine 100 has an operating system (OS) running thereon, and the OS has at least one service 101 and a Live-P2V logic functional entity 102 running thereon, wherein, the Live-P2V logic functional entity 102 is configured to after a target virtual machine 201 is created, started, and suspended by a virtualization platform VMM Host of the target virtual server 200, initially synchronize data of a memory page from the source physical machine 100 to the target virtual machine 201 at a second time point; monitor the operation of updating the memory page since the second time point; incrementally synchronize data of the updated memory page in the source physical machine 100 to the target virtual machine 201, and stop the monitoring when an increment value of the updated memory page in the source physical machine 100 is less than a first threshold; and call the virtualization platform of the target virtual server 200 to resume the target virtual machine 201 to a running state.

To be noted, in this embodiment, the source physical machine 100 still provides the service during the migration. Herein the operation of updating the memory page includes adding or deleting memory page, or modifying the data of the original memory pages, etc.

The target virtual server 200 is deployed with the virtualization platform VMM Host configured to create and start the target virtual machine 201, put the target virtual machine 201 in a suspended state, and resume the target virtual machine 201 to the running state in response to the calling by the Live-P2V logic functional entity 102. To be noted, the target virtual machine 201 is hosted on the virtualization platform VMM Host, a guest operating system 1 runs on the target virtual machine 201, and the service 101 runs on the guest operating system 1.

Under an implementation, in the embodiment of the present invention, the source physical machine 100 has an OS running thereon, and the OS has at least one service 101 and a Live-P2V logic functional entity 102 running thereon, wherein, the Live-P2V logic functional entity 102 is further configured to initially synchronize disk snapshot data from the source physical machine 100 to the target virtual machine 201 at a first time point; monitor a disk I/O writing operation in the source physical machine since the first time point; incrementally synchronize updated disk data in the source physical machine 100 to the target virtual machine 201, and stop the monitoring when an increment value of the disk I/O writing operation in the source physical machine is less than a second threshold; or stop the monitoring when a sum of the increment value of the disk I/O writing operation in the source physical machine and the increment value of the updated memory page is less than a third threshold.

And, under another implementation, before calling the target virtual server 200 to resume the target virtual machine 201 to the running state, the Live-P2V logic functional entity 102 is further configured to synchronize data of the updated memory page in the source physical machine 100 associated with the increment value to the target virtual machine 201, and synchronize updated disk data in the source physical machine 100 associated with the increment value to the target virtual machine 201. Thus an effect of data consistency is achieved through the last synchronization. That is, in this embodiment, the source physical machine provides services during the migration, and it only pauses when the aforementioned condition is satisfied, so as to synchronize the last updated disk data and memory page data.

Next, referring to FIG. 2, which is an application context diagram of a migration system according to an embodiment of the present invention, wherein source physical machines 100-1, 100-2 are communicatedly connected to the target virtual server 200 through an Ethernet switch 300. It shall be appreciated that the communication bridge between the source physical machines 100-1, 100-2 and the target virtual server 200 includes, but not limited to, the Ethernet switch 300, and other network devices may also be used.

Under a preferable implementation, the source physical machine and the target virtual server VMM Host locate in the same network and belong to the same segment, so as to ensure that the target virtual machine can continue to run using the IP of the source physical machine after completion of the migration.

Accordingly, under still another implementation, in the embodiment of the present invention, the source physical machine 100 has an OS running thereon, and the OS has at least one service 101 and a Live-P2V logic functional entity 102 running thereon, wherein, the Live-P2V logic functional entity 102 is further configured to bind the IP address of the source physical machine to the Mac address of the target virtual machine, and stop the source physical machine 100.

It can be seen that the embodiment of the present invention is adaptive to the scene of an online migration from a source physical machine to a target virtual machine. The data of the memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

Further, during the migration process from the source physical machine to the target virtual machine, the disk data modified by the source physical machine in the migration process is synchronized to the target virtual machine with functions of disk I/O monitoring and disk dirty data (i.e., the updated disk data block) synchronization, thereby ensuring that the disk data of the source physical machine is consistent with that of the target virtual machine, and improving migration reliability.

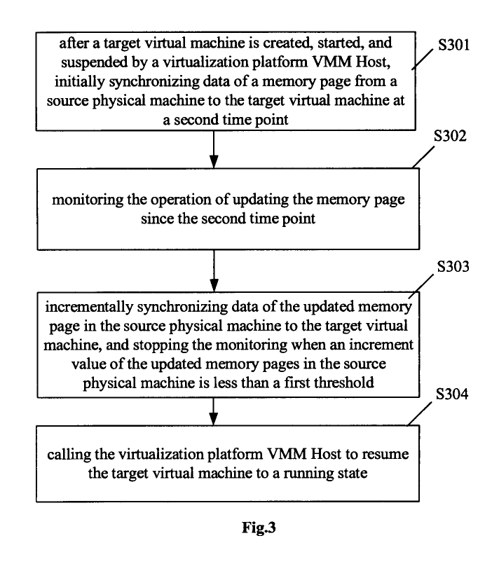

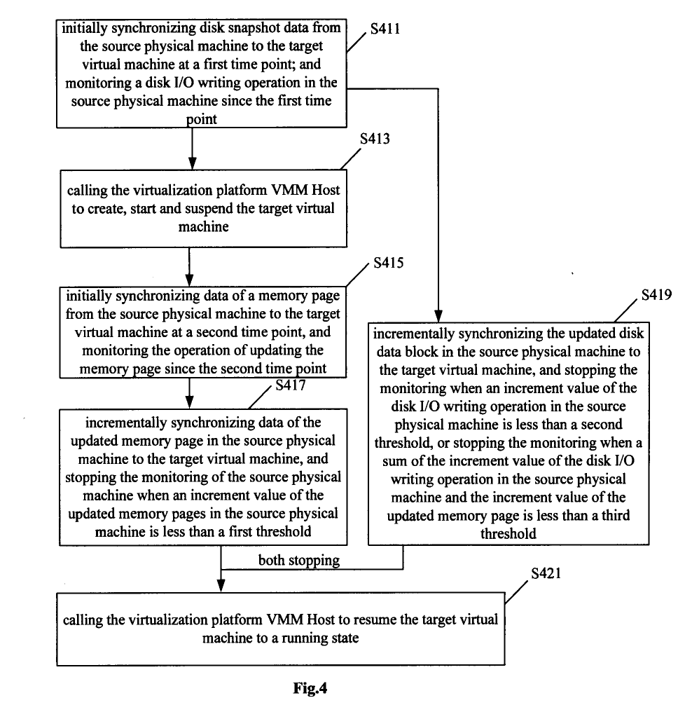

Referring to FIG. 3, which illustrates a method for online migrating from a physical machine to a virtual machine according to an embodiment of the present invention, and the method is adaptive to a source physical machine 100 having an OS running thereon, and the OS having at least one service 101 and a Live-P2V logic functional entity 102 running thereon. Specifically, the method is adaptive to the Live-P2V logic functional entity 102, including processess of:

S301: after a target virtual machine is created, started and suspended by a virtualization platform VMM Host, initially synchronizing data of a memory page from a source physical machine to the target virtual machine at a second time point;

S302: monitoring the operation of updating the memory page since the second time point;

Herein the second time point may be a timing at which the CPU of the source physical machine is in an idle state.

S303: incrementally synchronizing data of the updated memory page in the source physical machine, and stopping the monitoring of the source physical machine when an increment value of the updated memory page in the source physical machine is less than a first threshold;

To be noted, herein the incrementally synchronizing may be carried out at a preset cycle, e.g., at an interval of 1 s from the second time point, and the cycle may be flexibly set according to the actual application scene. Herein the increment value may be a size of data of the updated memory page in the source physical machine monitored in the current cycle and to be synchronized.

Alternatively, trigging the incrementally synchronizing once any data of the updated memory page is monitored.

Herein the first threshold may be obtained by comprehensively considering factors such as network speed, tolerable service interruption time, etc. Specifically, it may be calculated as follows: “threshold=network speed×tolerable service interruption time”. For example, when a certain service tolerates an interruption of 1 s at most, and the source physical machine and the target virtual server are connected to each other through a Gigabit network card, then the threshold=1,000 Mb/s×1 s=1,000 Mb data. That is, under an implementation, when it is monitored that the increment value of the updated memory page in the source physical machine is less than 1,000 Mb, the next process can be performed.

S304: calling the virtualization platform VMM Host to resume the target virtual machine to the running state.

It can be seen that the embodiment of the present invention is adaptive to the scene of an online migration from a source physical machine to a target virtual machine. The data of a memory page in the target virtual machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

Referring to FIG. 4, which illustrates another method for online migrating from a physical machine to a virtual machine according to an embodiment of the present invention, and the method is adaptive to a source physical machine 100 having an OS running thereon, and the OS having at least one service 101 and a Live-P2V logic functional entity 102 running thereon. Specifically, the method is adaptive to the Live-P2V logic functional entity 102, including processess of:

S411: initially synchronizing disk snapshot data from the source physical machine to the target virtual machine at a first time point; and monitoring a disk I/O writing operation in the source physical machine since the first time point;

In which, the process of monitoring the disk I/O writing operation in the source physical machine since the first time point specifically may include: inserting a probe function where the system is called in the source physical machine, wherein when a trap kernal event happens, the probe function is executed to judge whether the disk I/O writing operation occurs;

since the first time point, recording disk block update information when the disk I/O writing operation occurs in the source physical machine, herein the disk block update information represents the updated disk block (also referred to as dirty disk block).

S413: calling the virtualization platform VMM Host to create, start and suspend the target virtual machine;

S415: initially synchronizing data of a memory page from the source physical machine to the target virtual machine at the second time point, and monitoring the operation of updating the memory page since the second time point;

Herein the second time point may be a timing at which the CPU of the source physical machine is in an idle state.

In which, the process of monitoring the operation of updating the memory page since the second time point includes:

setting the attribute of the page table entry of the process space memory page of the source physical machine to be read-only;

since the second time point, when the memory page to which the page table entry points is updated, recording the memory page update information during the triggered exception handling process, herein the memory page update information represents the currently updated memory page (also referred to as dirty memory page), and accepting the update operation.

S417: incrementally synchronizing data of the updated memory page in the source physical machine to the target virtual machine, and stopping the monitoring of the source physical machine when an increment value of the updated memory page in the source physical machine is less than a first threshold;

Accordingly, the increment value of the updated memory page in the source physical machine is the size of the memory page associated with the memory page update information.

In which, the process of incrementally synchronizing data of the updated memory page in the source physical machine to the target virtual machine specifically may include: synchronizing data of the memory page that corresponds to the recorded memory page update information in the source physical machine to the target virtual machine according to the recorded memory page update information; and clearing the recorded memory page update information after the current synchronization operation is completed.

S419: incrementally synchronizing the updated disk data block in the source physical machine to the target virtual machine, and stopping the monitoring when an increment value of the disk I/O writing operation in the source physical machine is less than a second threshold; or stopping the monitoring when a sum of the increment value of the disk I/O writing operation in the source physical machine and the increment value of the updated memory page is less than a third threshold.

To be noted, herein the incrementally synchronizing may be carried out at a preset cycle, e.g., at an interval of 1 s from the second time point, and the cycle may be flexibly set according to the actual application scene.

In which, the process of incrementally synchronizing the updated disk data block in the source physical machine to the target virtual machine specifically may include: synchronizing disk data block that corresponds to the recorded disk block update information in the source physical machine to the target virtual machine according to the recorded disk block update information; and clearing the recorded disk block update information after the current synchronization operation is completed. Accordingly, the increment value of the disk I/O writing operation in the source physical machine is a size of the disk data block associated with the disk block update information.

S421: calling the virtualization platform VMM Host to resume the target virtual machine to a running state.

It can be seen that the embodiment of the present invention is adaptive to the scene of an online migration from a source physical machine to a target virtual machine. The data of a memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

Further, during the migration process from the source physical machine to the target virtual machine, the disk data modified by the source physical machine in the migration process is synchronized to the target virtual machine with functions of disk I/O monitoring and disk dirty data (i.e., the updated disk data block) synchronization, thereby ensuring that the disk data of the source physical machine is consistent with that of the target virtual machine, and improving the migration reliability.

The method according to the embodiment of the present invention is described in detail as follows in conjunction with the concrete application scenes.

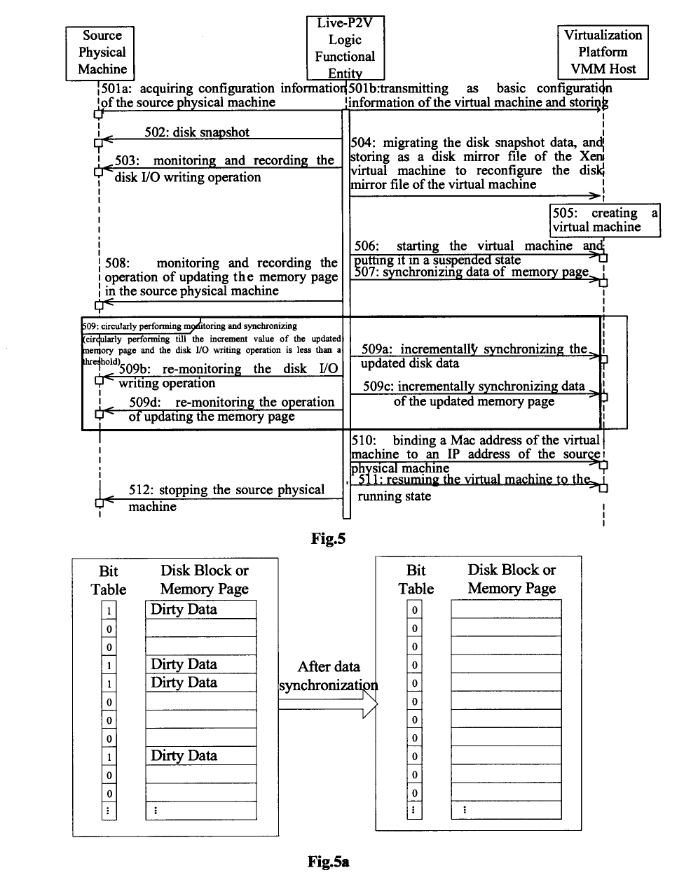

FIG. 5 is an interactive diagram of a method for online migrating from a physical machine to a virtual machine according to an embodiment of the present invention, and it is adaptive to the scene where the source physical machine is based on the Linux operating system, the VMM Host is a virtualization platform based on Xen, the Live-P2V logic function entity runs on the Linux operating system of the source physical machine (i.e., the Live-P2V software is installed in the source physical machine), the source physical machine runs normally, and the IP address of the source physical machine directly provides services to the exterior. As illustrated in FIG. 5, the method includes:

S501: the Live-P2V acquires the configuration information of the source physical machine, and transmits it to the VMM Host to be stored as the basic configuration information of the virtual machine;

Herein the configuration information of the source physical machine includes hardware and software information; specifically, the configuration information of the source physical machine includes CPU information, memory information, disk information, network card configuration information, etc.

Memory: cat/proc/meminfo

CPU: cat/proc/cpuinfo

Hard disk: df-h-T

Network card: ifconfig

S502: at the current first time point, the Live-P2V calls the LVM snapshot tool of the OS (Linux system in this embodiment) of the source physical machine to snapshot the disk and volume of the source physical machine, and then performs S503;

S503: the Live-P2V monitors a disk I/O writing operation in the source physical machine since the current first time point, and records the disk block update information; herein the disk block update information represents the updated data block in the disk of the source physical machine.

In which, the process of monitoring the disk I/O writing operation in the source physical machine includes: the Live-P2V inserts a probe function where the system is called in the source physical machine, and when a trap kernal event happens, the system executes the probe function, judges whether the disk writing operation occurs during the execution of the probe function, and since the first time point, records corresponding disk block update information when a disk writing operation occurs in the source physical machine; optionally, corresponding disk I/O writing operation may be recorded.

Under an implementation, the updated data block (also referred to as dirty data block) may be recorded by a bit table, wherein each bit corresponds to one disk block or memory page, and corresponding bit in the bit table is set as 1 when the current disk block or memory page is updated. If the data block is updated for several times, the record is made only once.

Referring to FIG. 5a, which is a record diagram of an updated data block according to an embodiment of the present invention. As illustrated in FIG. 5a, the information record of the dirty data block is cleared after current synchronization operation is completed. Specifically, all bits in the bit table are set as 0.

S504: the Live-P2V transmits the acquired disk snapshot data to the VMM Host on a data block basis, stores the disk snapshot data as a disk mirror file of the Xen virtual machine to reconfigure the disk mirror file of the Xen virtual machine, and notifies the VMM Host to create a virtual machine;

Specifically, the disk snapshot data is converted into the disk mirror file of the Xen virtual machine according to the type of the VMM Host virtualization platform and stored;

Specifically, according to the basic configuration information of the virtual machine in S501, reconfiguring the disk mirror file of the Xen virtual machine may include: updating Boot files, changing driving files, adding drivers of virtual hardware, and modifying device files including hda, hdb and cdrom as device files of the virtual machine.

S505: the VMM Host creates a virtual machine in the Xen OS through a VM Manager, and selects the disk mirror file of the virtual machine reconfigured in S505 as the virtual machine disk;

S506: the VMM Host starts the virtual machine through the VM Manager, and puts the virtual machine in a suspended state after the start is completed.

To be noted, the virtual machine automatically installs the driver according to the hardware when being started.

S507: at the current second time point, the Live-P2V synchronizes data of the memory page of the source physical machine to the virtual machine, and performs S508, wherein the second time point may be a timing at which the CPU of the source physical machine is in an idle state.

In which, the process of synchronizing data of the memory page of the source physical machine to the virtual machine includes:

calling a kernel mode program inserted into the kernel to read kernel space memory page in the source physical machine, and calling a user mode process to read process space memory page of each process running in the source physical machine; and

duplicating data of the read kernel space memory page in the source physical machine and all process space memory page data to the target virtual machine.

S508: the Live-P2V monitors the operation of updating the memory page in the source physical machine since the current second time point, and records the memory page update information;

In which, the process of monitoring the modification of the memory page in the source physical machine includes:

setting the attribute of the page table entry of the process space memory page to be read-only; and

when the memory page to which the page table entry points is updated, recording the currently updated memory page information (i.e., memory page update information) during the triggered exception handling process, and accepting the update operation.

To be noted, the kernel space memory page are fixed after the system starts to run, thus are unnecessary to be monitored. In the embodiment of the present invention, the modification of the process space memory page is mainly monitored. The process space memory page are usually modified by the applications and need to be monitored and recorded.

Under an implementation, like the record of the disk writing operation, a bit table is still used for the record. As illustrated in FIG. 5a, each bit corresponds to one memory page, and corresponding bit in the bit table is set as 1 when the memory page is updated, so as to record all updated memory pages.

S509: the Live-P2V circularly performs the following processes:

509a) incrementally synchronizing the updated disk data and performing 509b);

509b) re-monitoring and recording the disk 110 writing operation;

509c) incrementally synchronizing the updated memory page, preferably when the CPU of the source physical machine is in an idle state, and performing 509d);

509d) re-monitoring and recording the operation of updating the memory page;

exiting the circulation when the updated increment value (data amount) is less than a threshold.

To be noted, thresholds may be set for the updated disk I/O data and the updated memory page data, respectively, or a threshold may be set for a sum of the two data. Under an implementation, the setting rule may be that the threshold has such a size that under the condition of the current network the time for transmitting the data of the threshold is less than the time of service interruption or timeout, so as to avoid or relieve the problem of service pause.

With respect to the implementation of the incremental synchronization, as illustrated in FIG. 5a, searching the bit table for a bit identified as 1 and finding corresponding dirty data (i.e., disk block or memory page); copying corresponding dirty data to the target virtual machine and replacing the original data block or page when the operation type is modification; copying corresponding dirty data to the target virtual machine when, the operation type is addition; and directly deleting corresponding data block or memory page from the target virtual machine when the operation type is deletion.

Under an implementation, the threshold may be obtained by comprehensively considering factors such as network speed, tolerable service interruption time, etc. The threshold may be calculated as follows: “threshold=network speed×tolerable service interruption time”. For example, when a certain service tolerates an interruption of 1 s at most, and the source physical machine and the VMM Host are connected to each other through a Gigabit network card, then the threshold=1,000 Mb/s×1 s=1,000 Mb data. The next processes is performed when the data to be synchronized is less than 1,000 Mb.

S510: the Live-P2V binds the Mac address of the virtual machine to the IP address of the source physical machine;

Specifically, generating an arp data packet for binding the Mac address of the virtual machine to the IP address of the source physical machine, and broadcasting the arp data packet; that is, the Live-P2V can bind the Mac address of the virtual machine to the IP address of the source physical machine through an arp command.

S511: the VMM Host resumes the virtual machine to the running state;

To be noted, herein the resuming maintains the previous running state and now continues running, which is different from restarting because restarting is irrelevant to the previous running state.

S512: the Live-P2V stops the source physical machine, and specifically, may through a halt command.

In this embodiment, the source physical machine provides services during the migration, and it only pauses when the above condition is satisfied, so as to synchronize the last updated disk data and memory page data.

To be noted, S510 may also be performed after S512 (in that case, S511 follows S509), and the performance order can be flexibly changed upon the actual conditions.

It can be seen that the embodiment of the present invention is adaptive to the scene of an online migration from a source physical machine to a target virtual machine. The data of a memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

Further, during the migration process from the source physical machine to the target virtual machine, the disk data modified by the source physical machine in the migration process is synchronized to the target virtual machine with functions of disk I/O monitoring and disk dirty data synchronization, thereby ensuring that the disk data of the source physical machine is consistent with that of the target virtual machine, and improving the migration reliability.

Further, by binding the Mac address of the virtual machine to the IP address of the source physical machine, the services previously in a communicative interaction with the source physical machine can continue to communicate with the target virtual machine.

Another embodiment of the present invention is adaptive to the scene where the IP address of the source physical machine does not provide any service to the exterior directly, but tasks are allocated by another device, and accordingly, S510 can be omitted.

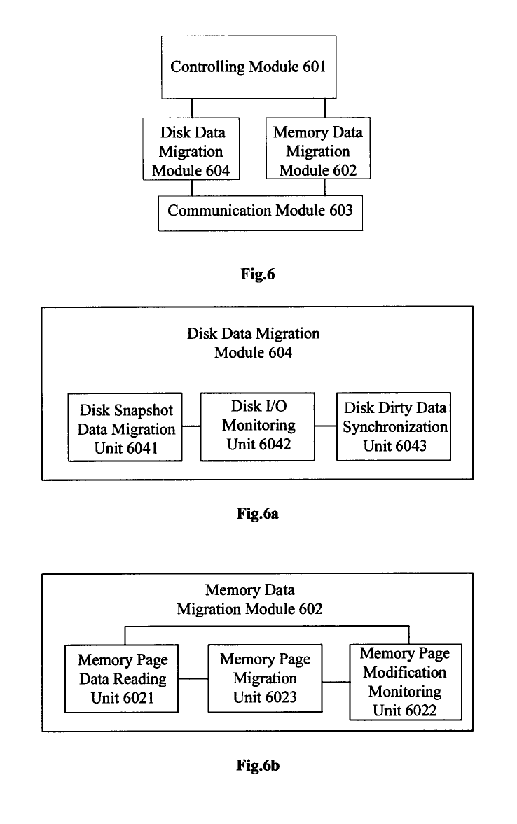

Referring to FIG. 6, which is a structural diagram of an online Live-P2V logic functional entity according to an embodiment of the present invention. The Live-P2V logic functional entity is adaptive to the scene of an online migration from a source physical machine to a target virtual machine. As illustrated in FIG. 6, the Live-P2V logic functional entity includes a controlling module 601, a memory data migration module 602 and a communication module 603, wherein:

the controlling module 601 is configured to call a virtualization platform VMM Host to perform the control of creating, starting and suspending a target virtual machine, and call the VMM Host to resume the target virtual machine to a running state in response to the stop of monitoring by the memory data migration module 602;

the communication module 603 is configured to provide a data migration channel from the source physical machine to the target virtual machine; under an implementation, the data migration channel specifically may be a socket connection;

the memory data migration module 602 is configured to initially synchronize data of a memory page from the source physical machine to the target virtual machine through the data migration channel at a second time point, after the target virtual machine is suspended; monitor the operation of updating the memory page since the second time point; incrementally synchronize data of the updated memory page in the source physical machine to the target virtual machine through the data migration channel, and stop the monitoring when an increment value of the updated memory page in the source physical machine is less than a first threshold.

Herein the second time point preferably may be a timing at which the CPU of the source physical machine is in an idle state.

Under an implementation, the embodiment of the present invention further includes:

a disk data migration module 604 configured to initially synchronize disk snapshot data from the source physical machine to the target virtual machine through the data migration channel at a first time point, monitor the disk I/O writing operation in the source physical machine since the first time point, incrementally synchronize the updated disk data in the source physical machine to the target virtual machine through the data migration channel, and stop the monitoring when an increment value of the disk I/O writing operation in the source physical machine is less than a second threshold; or stop the monitoring when a sum of the increment value of the disk I/O writing operation in the source physical machine and the increment value of the updated memory page is less than a third threshold.

Accordingly, the controlling module 601 is a first controlling module configured to call a virtualization platform VMM Host to perform the control of creating, starting and suspending a target virtual machine, and call the VMM Host to resume the target virtual machine to a running state in response to the stop of monitoring by the memory data migration module 602 and the first disk data migration module 604.

Preferably, in the embodiment of the present invention, the controlling module 601 is further configured to bind the IP address of the source physical machine to the Mac address of the target virtual machine, and stop the source physical machine.

It can be seen that the embodiment of the present invention is adaptive to the scene of an online migration from a source physical machine to a target virtual machine. The data of a memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine. Further, during the migration process from the source physical machine to the target virtual machine, the disk data modified by the source physical machine in the migration process is synchronized to the target virtual machine with functions of disk I/O monitoring and disk dirty data synchronization, thereby ensuring that the disk data of the source physical machine is consistent with that of the target virtual machine, and improving the migration reliability.

Further, by binding the Mac address of the target virtual machine to the IP address of the source physical machine, the services previously in a communicative interaction with the source physical machine can continue to communicate with the target virtual machine.

Referring to FIG. 6a, which is an internal logic structural diagram of a disk data migration module 604 in a Live-P2V logic functional entity according to an embodiment of the present invention. As illustrated in FIG. 6a, the disk data migration module 604 includes a disk snapshot data migration unit 6041, a disk I/O monitoring unit 6042, and a disk dirty data synchronization unit 6043, wherein:

the disk snapshot data migration unit 6041 is configured to call a snapshot tool of the OS of the source physical machine to snapshot the disk of the source physical machine at a first time point, convert the acquired disk snapshot data into corresponding disk mirror file of the virtual machine according to the type of the VMM Host virtualization platform, and transmit to the VMM Host through the data migration channel;

the disk VO monitoring unit 6042 is configured to insert a probe function where the system is called, and since a first time point, trigger the probe function to judge whether a disk I/O writing operation occurs when the probe function is executed; record disk update information when a disk I/O writing operation occurs, and stop the monitoring when an increment value of the disk I/O writing operation in the source physical machine is less than a second threshold, or stop the monitoring when a sum of the increment value of the disk I/O writing operation in the source physical machine and the increment value of the updated memory page is less than a third threshold; the disk update information represents the corresponding updated data block (also referred to as dirty data block); optionally, the corresponding disk writing operation information may also be recorded.

In which, the increment value of the disk I/O writing operation in the source physical machine is the size of the disk data block associated with the disk block update information.

The disk dirty data synchronization unit 6043 is configured to synchronize a disk data block that corresponds to the recorded disk update information to the target virtual machine according to the recorded disk update information. To be noted, the synchronization may be a periodic copying, e.g., a copying operation is performed since the start time at an interval of 1 s.

Accordingly, the disk I/O monitoring unit 6042 is further configured to clear the information record of the dirty data block (i.e., disk update information) after the current synchronization operation is completed. Under an implementation, all bits in the bit table as illustrated in FIG. 5a are set as 0 after the current synchronization is completed.

Referring to FIG. 6b, which is an internal logic structural diagram of a memory data migration module 602 in a Live-P2V logic functional entity according to an embodiment of the invention. As illustrated in FIG. 6b, the memory data migration module 602 includes a memory page data reading unit 6021, a memory page modification monitoring unit 6022 and a memory page migration unit 6023, wherein:

the memory page data reading unit 6021 is configured to, at a second time point, call a kernel mode program inserted into the kernel of the source physical machine to read kernel space memory page in the system, and call a user mode process to read all process space memory pages;

specifically, the kernel mode program herein has the authority to access the Linux kernel global variable swapper_pg_dir to acquire the kernel page directories, thereby accessing each kernel memory page; and the user mode process herein traverses the page directories and page tables of each process, accesses the process address space in a range of 0 to 3 G, acquires corresponding physical page, and performs a migration to the virtual machine.

The memory page modification monitoring unit 6022 is configured to set the attribute of the page table entry of the process space memory page to be read-only since the second time point, and when the memory page to which the page table entry points is updated, record the memory page update information representing the currently updated memory page during the triggered exception handling process, accept the update operation, and stop the monitoring when the increment value of the updated memory page is less than a first threshold. In which, the increment value of the updated memory page in the source physical machine is the size of the memory page associated with the memory page update information.

To be noted, the kernel space memory page is fixed after the system starts to run, so is unnecessary to be monitored. In the embodiment of the present invention, the modification of the process space memory page is mainly monitored. The process space memory page is usually modified by the applications and needs to be monitored and recorded. Under an implementation, like the record of the disk writing operation, a bit table is still used for the record. As illustrated in FIG. 5a, each bit corresponds to one memory page, and corresponding bit in the bit table is set as 1 when the memory page is updated, so as to record all updated memory pages.

The memory page migration unit 6023 is configured to migrate data of memory page read by the memory page data reading unit 6021 to the target virtual machine through the data migration channel, and incrementally synchronize data of the memory page that corresponds to the recorded memory page update information in the source physical machine to the target virtual machine through the data migration channel according to the recorded memory page update information.

To be noted, the synchronization may be periodic, e.g., a copying operation is performed since the start time at an interval of 1 s. In the implementation, searching the bit table for a bit identified as 1, synchronizing the memory page corresponding to the bit identified as 1 to the target virtual machine, clearing the bit table after the migration is completed and setting all the bits as 0.

Accordingly, the memory page modification monitoring unit 6022 is further configured to clear the information record of the dirty data block after the current incremental synchronization operation is completed. Under an implementation, all bits in the bit table as illustrated in FIG. 5a are set as 0 after the current synchronization is completed.

In summary, the embodiments of the present invention are applied in the scene of an online migration from a source physical machine to a target virtual machine. The data of a memory page in the source physical machine is synchronized or migrated to the target virtual machine by synchronizing the memory data and monitoring the memory page update. In this way, the running states and contexts of all services and processes of the source physical machine are stored in the target virtual machine. In other words, a target virtual machine having a running state substantially the same as that of the source physical machine is created, so that following the state of the source physical machine, the target virtual machine takes over and continues running, avoiding the problem of service interruption and achieving the effect of smoothly switching services from the source physical machine to the target virtual machine.

Further, during the migration process from the source physical machine to the target virtual machine, the disk data modified by the source physical machine in the migration process is synchronized to the target virtual machine with functions of disk I/O monitoring and disk dirty data synchronization, thereby ensuring that the disk data of the source physical machine is consistent with that of the target virtual machine, and improving the migration reliability.

Further, by binding the Mac address of the virtual machine to the IP address of the source physical machine, the services previously in a communicative interaction with the source physical machine can continue to communicate with the target virtual machine.

A person skilled in the art shall appreciate that all or a part of flows in the methods according to the above embodiments may be implemented by instructing relevant hardware through a program that may be stored in a computer readable storage medium, and when being executed, the program may include the flows of the method embodiments. In which, the storage medium may be magnetic disk, optical disk, Read-Only Memory (ROM) or Random Access Memory (RAM), etc.

The above descriptions are just a few embodiments of the present invention, and a person skilled in the art can make various changes or modifications to the present invention based on the disclosure of the application document, without deviating from the spirit and scope of the present invention.

What is claimed is:

1. A method for online migrating from a physical machine to a virtual machine, comprising processes of:
after a target virtual machine is created, started and suspended by a virtualization platform VMM Host, initially synchronizing data of a memory page from a source physical machine to the target virtual machine at a second time point;
monitoring the operation of updating the memory page since the second time point;
incrementally synchronizing data of the updated memory page in the source physical machine to the target virtual machine, and stopping the monitoring when an increment value of the updated memory page in the source physical machine is less than a first threshold; and
calling the virtualization platform VMM Host to resume the target virtual machine to a running state.

2. The method for online migrating according to claim 1, further comprising processes of:
initially synchronizing disk snapshot data from the source physical machine to the target virtual machine at a first time point;
monitoring a disk I/O writing operation in the source physical machine since the first time point; and
incrementally synchronizing an updated disk data block in the source physical machine to the target virtual machine, and stopping the monitoring when an increment value of the disk I/O writing operation in the source physical machine is less than a second threshold; or stopping the monitoring when a sum of the increment value of the disk I/O writing operation in the source physical machine and the increment value of the updated memory page is less than a third threshold

3. The method for online migrating according to claim 1, wherein the process of monitoring the operation of updating the memory page since the second time point comprises:
setting the attribute of the page table entry of the process space memory page of the source physical machine to be read-only; and
since the second time point, when the memory page to which the page table entry points is updated, recording memory page update information during a triggered exception handling process, and accepting the update operation; wherein the increment value of the updated memory page in the source physical machine is a size of the memory page associated with the memory page update information.

4. The method for online migrating according to claim 2, wherein the process of monitoring the operation of updating the memory page since the second time point comprises:
setting the attribute of the page table entry of the process space memory page of the source physical machine to be read-only; and
since the second time point, when the memory page to which the page table entry points is updated, recording memory page update information during a triggered exception handling process, and accepting the update operation; wherein the increment value of the updated memory page in the source physical machine is a size of the memory page associated with the memory page update information.

5. The method for online migrating according to claim 2, wherein the process of monitoring the disk I/O writing operation in the source physical machine since the first time point comprises:
inserting a probe function where a system is called in the source physical machine, wherein when a trap kernal event happens, the probe function is executed to judge whether the disk I/O writing operation occurs; and
since the first time point, recording disk block update information when the disk I/O writing operation occurs in the source physical machine, wherein the increment value of the disk I/O writing operation in the source physical machine is a size of the disk data block associated with the disk block update information.

6. The method for online migrating according to claim 3, wherein the process of incrementally synchronizing data of the updated memory page in the source physical machine to the target virtual machine comprises: synchronizing data of the memory page that corresponds to the recorded memory page update information in the source physical machine to the target virtual machine according to the recorded memory page update information; and
clearing the recorded memory page update information after current synchronization operation is completed.

7. The method for online migrating according to claim 4, wherein the process of incrementally synchronizing data of the updated memory page in the source physical machine to the target virtual machine comprises: synchronizing data of the memory page that corresponds to the recorded memory page update information in the source physical machine to the target virtual machine according to the recorded memory page update information; and
clearing the recorded memory page update information after current synchronization operation is completed.

8. The method for online migrating according to claim 5, wherein the process of incrementally synchronizing the updated disk data block in the source physical machine to the target virtual machine comprises: synchronizing the disk data block that corresponds to the recorded disk block update information in the source physical machine to the target virtual machine according to the recorded disk block update information; and
clearing the recorded disk block update information after current synchronization operation is completed.

9. The method for online migrating according to claim 1, further comprising the process of binding an IP address of the source physical machine to a Mac address of the target virtual machine, and stopping the source physical machine.

10. The method for online migrating according to claim 2, further comprising the process of binding an IP address of the source physical machine to a Mac address of the target virtual machine, and stopping the source physical machine.

11. An online Live-P2V logic functional entity, comprising: a controlling module, a memory data migration module and a communication module, wherein,
the controlling module is configured to call a virtualization platform VMM Host to perform the control of creating, starting and suspending a target virtual machine, and call the virtualization platform to resume the target virtual machine to a running state in response to a stop of monitoring by the memory data migration module;
the communication module is configured to provide a data migration channel from a source physical machine to the target virtual machine; and
the memory data migration module is configured to initially synchronize data of memory page from the source physical machine to the target virtual machine through the data migration channel at a second time point, after the target virtual machine is suspended; monitor the operation of updating the memory page since the second time point; incrementally synchronize data of the updated memory page in the source physical machine to the target virtual machine through the data migration channel, and stop the monitoring when an increment value of the updated memory page in the source physical machine is less than a first threshold.

12. The online Live-P2V logic functional entity according to claim 11, further comprising:
a disk data migration module configured to initially synchronize disk snapshot data from the source physical machine to the target virtual machine through the data migration channel at a first time point, monitor a disk I/O writing operation in the source physical machine since the first time point, incrementally synchronize updated disk data in the source physical machine to the target virtual machine through the data migration channel, and stop the monitoring when an increment value of the disk I/O writing operation in the source physical machine is less than a second threshold; or stop the monitoring when a sum of the increment value of the disk I/O writing operation in the source physical machine and the increment value of the updated memory page is less than a third threshold; and
the controlling module is specifically configured to call the virtualization platform to perform the control of creating, starting and suspending the target virtual machine, and call the virtualization platform to resume the target virtual machine to a running state in response to the stop of monitoring by the memory data migration module and the disk data migration module.

13. The online Live-P2V logic functional entity according to claim 11, wherein the controlling module is further configured to bind an IP address of the source physical machine to a Mac address of the target virtual machine, and stop the source physical machine.

14. The online Live-P2V logic functional entity according to claim 12, wherein the controlling module is further configured to bind an IP address of the source physical machine to a Mac address of the target virtual machine, and stop the source physical machine.

15. A migration system adaptive to an online migration from a source physical machine to a target virtual machine, the system comprising the source physical machine and a target virtual server in a network connection, wherein:
the source physical machine has an operating system (OS) running thereon, and the OS has at least one service and an online Live-P2V logic functional entity running thereon, the online Live-P2V logic functional entity being configured to after the target virtual machine is created, started, and suspended by a virtualization platform VMM Host of the target virtual server, initially synchronize data of memory page from the source physical machine to the target virtual machine at a second time point, monitor the operation of updating the memory page from the second time point, incrementally synchronize data of the updated memory page in the source physical machine to the target virtual machine, and stop the monitoring when an increment value of the updated memory page in the source physical machine is less than a first threshold, and call the virtualization platform of the target virtual server to resume the target virtual machine to a running state;
the target virtual server is deployed with the virtualization platform, wherein the virtualization platform is configured to create and start the target virtual machine, put the target virtual machine in a suspended state, and resume the target virtual machine to the running state in response to calling by the online Live-P2V logic functional entity.

16. The migration system according to claim 15, wherein the online Live-P2V logic functional entity is further configured to initially synchronize disk snapshot data from the source physical machine to the target virtual machine at a first time point; monitor a disk I/O writing operation in the source physical machine since the first time point; incrementally synchronize updated disk data in the source physical machine to the target virtual machine, and stop the monitoring when an increment value of the disk I/O writing operation in the source physical machine is less than a second threshold; or stop the monitoring when a sum of the increment value of the disk I/O writing operation in the source physical machine and the increment value of the updated memory page is less than a third threshold.

17. A computer-readable medium having computer executable instructions for performing a method for online migrating from a physical machine to a virtual machine comprising:
after a target virtual machine is created, started and suspended by a virtualization platform VMM Host, initially synchronizing data of a memory page from a source physical machine to the target virtual machine at a second time point;
monitoring the operation of updating the memory page since the second time point;
incrementally synchronizing data of the updated memory page in the source physical machine to the target virtual machine, and stopping the monitoring when an increment value of the updated memory page in the source physical machine is less than a first threshold; and
calling the virtualization platform VMM Host to resume the target virtual machine to a running state.
